(19) United States
(12) Patent Application Publication
(10) Pub. No.: US 2023/0334406 A1
(43) Pub. Date: Oct. 19, 2023

(54) INFERENCE APPARATUS, INFERENCE METHOD, AND RECORDING MEDIUM

(71) Applicant: Hitachi, Ltd., Tokyo (JP)

(72) Inventors: Shunichi AKATSUKA, Tokyo (JP); Susumu SERITA, Tokyo (JP); Toshihiro KUJIRAI, Tokyo (JP)

(21) Appl. No.: 18/115,081

(22) Filed: Feb. 28, 2023

(30) Foreign Application Priority Data
Apr. 15, 2022 (JP) 2022-67840

(51) Int. Cl. G06Q 10/0637; G06Q 10/0631; G06Q 50/30

(52) U.S. Cl. CPC G06Q 10/06375; G06Q 10/06315; G06Q 50/30

(57) ABSTRACT

An inference apparatus includes: an inference module configured to infer a modification plan for modification target data by inputting, for each of agents, a state of the each of the agents to a policy model of the each of the agents which is related to the modification target data, and by acquiring an action of the each of the agents, and store, as experience data, the state and the action of each of the agents as well as a reward earned by taking the action; an evaluation module configured to calculate an evaluation value for each of the agents, the evaluation value being a probability at which the action is selected under the state; and a modification module configured to modify the experience data based on the evaluation value of each of the agents calculated by the evaluation module.

### CLAIM OF PRIORITY

The present application claims priority from Japanese patent application JP 2022-67840 filed on Apr. 15, 2022, the content of which is hereby incorporated by reference into this application.

### BACKGROUND

This invention relates to an inference apparatus for inferring data, an inference method, and a recording medium.

One of tasks of managing railroad operation is an operation arrangement task for remedying disruptions caused by a delay and the like to a planned diagram to return to the planned diagram. In the operation arrangement task, the return to the planned diagram is required to be accomplished by changing schedules of a large number of trains through a combination of several operation arrangement manipulations. A method of changing a current schedule is referred to as “operation arrangement.” The railroad operation arrangement task means to output an optimum operation arrangement plan by combining operation arrangements. There is a massive number of combinations of operation arrangements for a large number of stations multiplied by a large number of trains. Accordingly, a search of all of the combinations is impossible and automation of the task is difficult. One way to address this is to obtain a solution with use of reinforcement learning.

Reinforcement learning is an unsupervised learning method in which an optimum solution is learned by trial and error without training data, and is a framework in which an agent of action observes a state that is a part of an environment and determines an action to take in response to the state. The agent observes a new state that develops as a result of the action, and is rewarded. A manner of determining, based on many experiences, an action to take in response to a state that maximizes a reward, that is, a method of learning policies, is reinforcement learning. In deep reinforcement learning which uses a deep network as a model expressing a policy, a large quantity of experiences of trial and error are often stored in an experience buffer to repeatedly make use of past experiences for efficient learning.

In single-agent reinforcement learning which sets only one agent in an environment, problem setting that involves simultaneous execution of many manipulations creates a massive number of combinations in some cases. For instance, in the railroad operation arrangement task, operation of all delaying trains is required to be arranged at relevant stations, and there is accordingly an enormous number of combinations of possible actions to be taken.

This issue of a massive number of combinations is avoidable in multi-agent reinforcement learning which sets a plurality of agents in an environment. Multi-agent reinforcement learning is a framework in which many agents act at the same time, and the number of actions that may possibly be taken per agent can accordingly be small. One of problems to be solved in multi-agent reinforcement learning is an issue of non-stationarity of an environment due to simultaneous learning by a plurality of agents.

In multi-agent reinforcement learning, one agent views another agent as a part of the environment and learns its own policy from that perspective. In actuality, however, other agents are not a part of the environment, and change their actions as their learning progresses. This causes the environment to seem, to the one agent, constantly changing.

When trying to learn by making use of past data stored in the experience buffer, the one agent is required to learn the policy in such a non-stationary environment, with the result that the Markov property assumed in reinforcement learning is lost. For that reason, convergence of the policy is generally unguaranteed. This issue is solvable by setting a very short time span to the experience buffer so that only most recently collected data is referred to. In this case, however, an enormous amount of past experience is discarded, and a known consequence thereof is poor learning efficiency, or a failure to converge on an optimum policy.

In J. Foerster et. al., “Stabilising Experience Replay for Deep Multi-Agent Reinforcement Learning,” ICML 2017, (hereinafter referred to as “Foerster”), there are disclosed a method of using a multi-agent variant of importance sampling to naturally decay obsolete data and a method of conditioning each agent's value function on a footprint that disambiguates the age of data sampled from a replay memory.

However, Foerster is not effective because data collected at early stages becomes hardly used as the number of agents increases. It is accordingly required to analyze which action of an agent in past data is a cause of non-stationarity and handle data accordingly.

### SUMMARY

An object of this invention is to reduce non-stationarity of past data used for multi-agent inference.

An aspect of the disclosure in the present application is an inference apparatus, comprising: an inference module configured to infer a modification plan for modification target data by inputting, for each of a plurality of agents, a state of the each of the plurality of agents to a policy model of the each of the plurality of agents which is related to the modification target data, and by acquiring an action of the each of the plurality of agents, and store, as experience data, the state and the action of each of the plurality of agents as well as a reward earned by taking the action; an evaluation module configured to calculate an evaluation value for each of the plurality of agents, the evaluation value being a probability at which the action is selected under the state; and a modification module configured to modify the experience data based on the evaluation value of each of the plurality of agents calculated by the evaluation module.

According to the at least one representative embodiment of this invention, non-stationarity of past data used for multi-agent inference can be reduced. The details of one or more implementations of the subject matter described in the specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram for illustrating a configuration example of an inference apparatus.

FIG. 2 is an explanatory diagram for showing an example of the diagram information.

FIG. 3 is an explanatory diagram for illustrating a structure example of the experience data stored in the experience buffer.

FIG. 4 is a flow chart for illustrating an example of multi-agent inference processing steps executed by the multi-agent inference program.

FIG. 5 is a flow chart for illustrating an example of model learning processing steps executed by the reinforcement learning program.

FIG. 6 is a flow chart for illustrating an example of detailed processing steps of the experience data evaluation processing (Step S505) executed by the experience data evaluation program.

FIG. 7 is a flow chart for illustrating an example of detailed processing steps of the experience data modification processing (Step S507) executed by the experience data modification program.

FIG. 8 is a flow chart for illustrating an example of detailed processing steps of the experience data weight calculation processing (Step S508) executed by the experience data weight calculation program.

FIG. 9 is a graph for showing the planned diagram.

FIG. 10 is a graph for showing the post-delay diagram.

FIG. 11 is a graph for showing an example of the modified diagram.

FIG. 12 is a graph for showing another example of the modified diagram.

FIG. 13 is an explanatory diagram for showing an example of a reward table.

FIG. 14 is a table for showing a relationship between a similarity degree evaluation value with respect to the experience data and a weight parameter.

FIG. 15 is an explanatory diagram for illustrating at what probability each piece of original experience data is modified by the experience data modification processing (Step S507).

FIG. 16 is an explanatory diagram for illustrating an example of reinforcement learning by the inference apparatus.

### DETAILED DESCRIPTION OF THE EMBODIMENTS

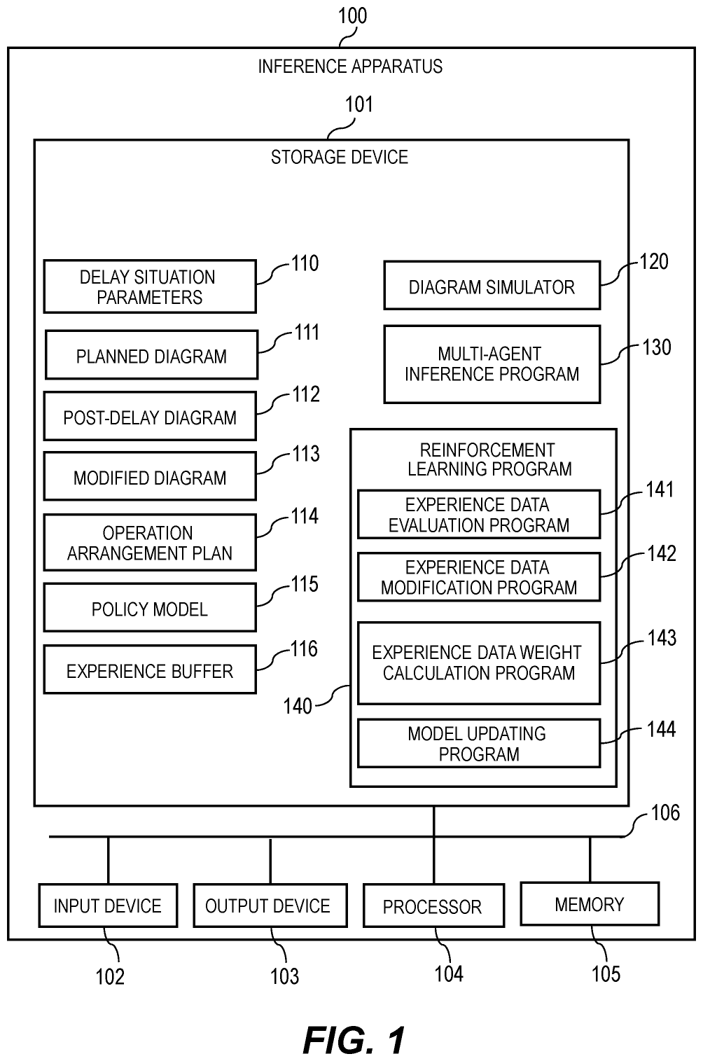

At least one embodiment of this invention is described below with reference to FIG. 1 to FIG. 13. In the following description, although a program causes a processor to execute predetermined processing, the program is described as an executor of the processing in some places for the convenience of description.

### Configuration Example of Inference Apparatus

FIG. 1 is a block diagram for illustrating a configuration example of an inference apparatus. An inference apparatus 100 proposes, when a delay occurs in train operation, a new plan that solves the delay situation. The inference apparatus 100 includes, as hardware, a storage device 101, an input device 102, an output device 103, a processor 104, a memory 105, and a bus 106.

The storage device 101 is also a non-transitory or transitory recording medium configured to store various programs and various kinds of data.

Examples of the storage device 101 include a read only memory (ROM), a random-access memory (RAM), a hard disk drive (HDD), and a flash memory.

The input device 102 is configured to input data. Examples of the input device 102 include a keyboard, a mouse, a touch panel, a numeric keypad, a scanner and a sensor.

The output device 103 is configured to output data. Examples of the output device 103 include a display, a printer, a speaker and a communication interface.

The processor 104 is configured to control the inference apparatus 100. The processor 104 is configured to execute programs stored in the storage device 101.

The memory 105 serves as a work area for the processor 104. Examples of the memory 105 include a RAM.

The storage device 101 stores delay situation parameters 110, a planned diagram 111, a post-delay diagram 112, a modified diagram 113, an operation arrangement plan 114, a policy model 115, an experience buffer 116, a diagram simulator 120, a multi-agent inference program 130, and a reinforcement learning program 140. The processor 104 executes the multi-agent inference program 130 and the reinforcement learning program 140 stored in the storage device 101, to thereby implement a function of outputting the operation arrangement plan 114 suited to an input delay situation with use of the policy model 115, and a function of learning the policy model 115 with use of the diagram simulator 120.

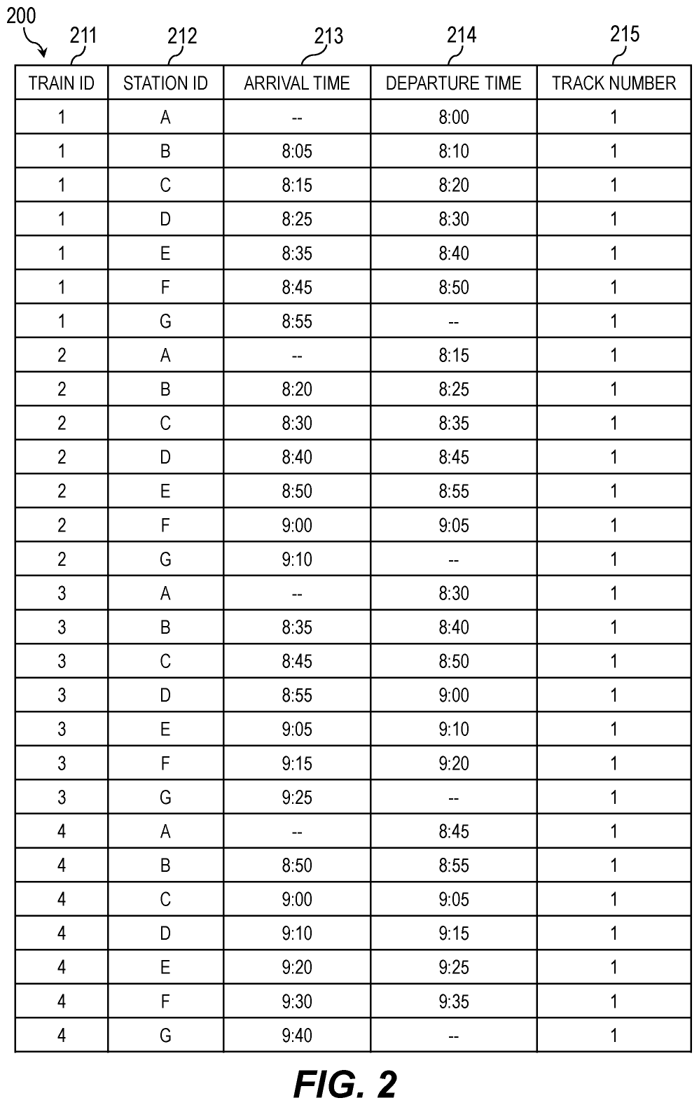

The diagram simulator 120 predicts a diagram to be implemented based on diagram information and information about a schedule change with respect to the diagram information, and outputs the predicted diagram. The diagram information is information indicating a train operation schedule used for control of trains. The diagram information includes an arrival time and a departure time of every train at every station. A transit time of every train at every station may be included in the diagram information. A specific example of the diagram information is described later with reference to FIG. 2. The information about a schedule change is the delay situation parameters 110 described later, or the operation arrangement plan 114 described later.

The diagram simulator 120 holds a constraint condition to be satisfied by the output predicted diagram. The constraint condition is, for example, a condition about a minimum stopping time at a station, a condition about a minimum time interval between trains, or a condition about an order in which trains depart from a station. The diagram simulator 120 outputs a predicted diagram that satisfies the constraint condition. When an operation arrangement that does not conform to the constraint condition is given, the diagram simulator 120 outputs constraint violation information indicating which part fails to satisfy the constraint in what manner.

The delay situation parameters 110 are data indicating a situation of a delay. Specifically, when an accident requires a train to stop at a station for a certain length of time, for example, information specifying this train in the planned diagram 111, information specifying this station in the planned diagram 111, and information of a foreseen delay time are input as the delay situation parameters 110 to the inference apparatus 100. The delay situation parameters 110 thus include information required for the diagram simulator 120 to output the post-delay diagram 112 by reading the information.

The planned diagram 111 is the diagram information at a time of planning prior to occurrence of a delay. A specific example of the diagram information is described later with reference to FIG. 2.

The post-delay diagram 112 is a diagram after a delay that is predicted to be implemented when a delay corresponding to the delay situation parameters 110 occurs with respect to the planned diagram 111, and no operation arrangement is executed. The post-delay diagram 112 is created by the diagram simulator 120 based on the planned diagram 111 and the delay situation parameters 110.

The modified diagram 113 is a diagram predicted to be implemented when the operation arrangement plan 114 generated by the multi-agent inference program 130 is applied to the post-delay diagram 112. The modified diagram 113 is generated with the use of the diagram simulator 120 based on the post-delay diagram 112 and the operation arrangement plan 114.

The operation arrangement plan 114 is data indicating a method of a change to be applied to the diagram information. The operation arrangement plan 114 is a list of operation arrangement manipulations. The operation arrangement manipulations are manipulations of applying changes to the diagram information, and examples of the operation arrangement manipulations include a manipulation of switching an order of two specified trains in an operation section starting from a specified station by specifying two trains and one station, and a manipulation of changing the diagram information so that a specified track is used by specifying one train, one station, and a track number of a track at that station.

The diagram simulator 120 reads the diagram information and the operation arrangement plan 114 to output new diagram information that satisfies the constraint condition.

The policy model 115 is data used by the multi-agent inference program 130 described later, and is a set of functions required to output an operation arrangement plan based on the planned diagram 111, the post-delay diagram 112, and the modified diagram 113. The policy model 115 includes at least one variable (policy parameter).

The operation arrangement plan 114 that is output changes by changing the at least one policy parameter. The policy model 115 may contain a plurality of functions. The policy model 115 is implemented by, for example, a neural network or a decision tree. The at least one policy parameter is updated by the reinforcement learning program 140 described later.

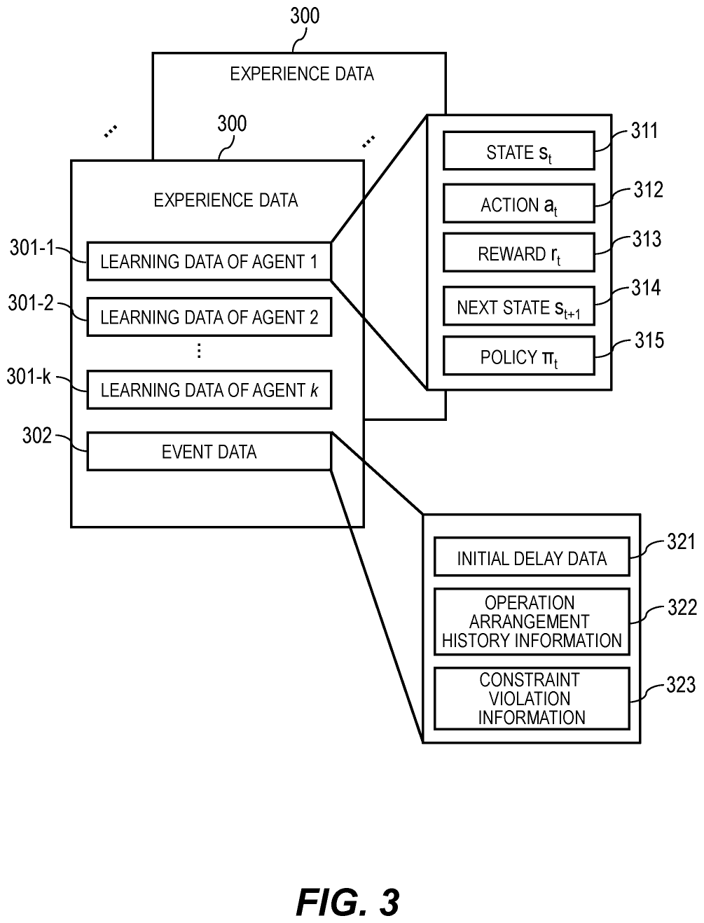

The experience buffer 116 is a storage area for storing history information of inference executed in the past by the multi-agent inference program 130. The history information of inference executed in the past by the multi-agent inference program 130 is hereinafter referred to as “experience data.” A specific example of the experience data is described later with reference to FIG. 3.

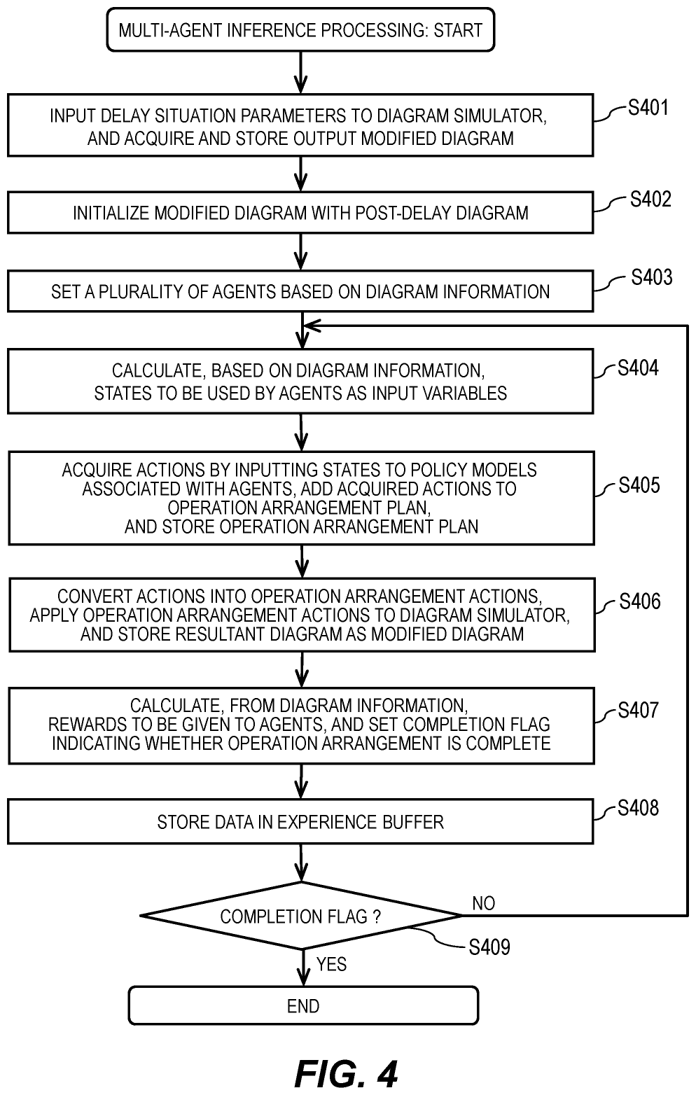

The multi-agent inference program 130 is a program that causes the processor 104 to execute inference of the operation arrangement plan 114 with use of a plurality of agents, and causes the processor 104 to function as an inference module. Specifically, for example, the multi-agent inference program 130 calculates the operation arrangement plan 114 with respect to the planned diagram 111, the post-delay diagram 112, and the modified diagram 113 with the use of the policy model 115. The multi-agent inference program 130 sets at least two agents, which are executors of processing of calculating the operation arrangement plan 114 when the diagram information is given, and calculates operation arrangement by applying each policy model 115 associated with one of those agents at the same time, or one policy model at a time, to thereby output the final operation arrangement plan 114. A specific processing example of the multi-agent inference program 130 is described later with reference to FIG. 4.

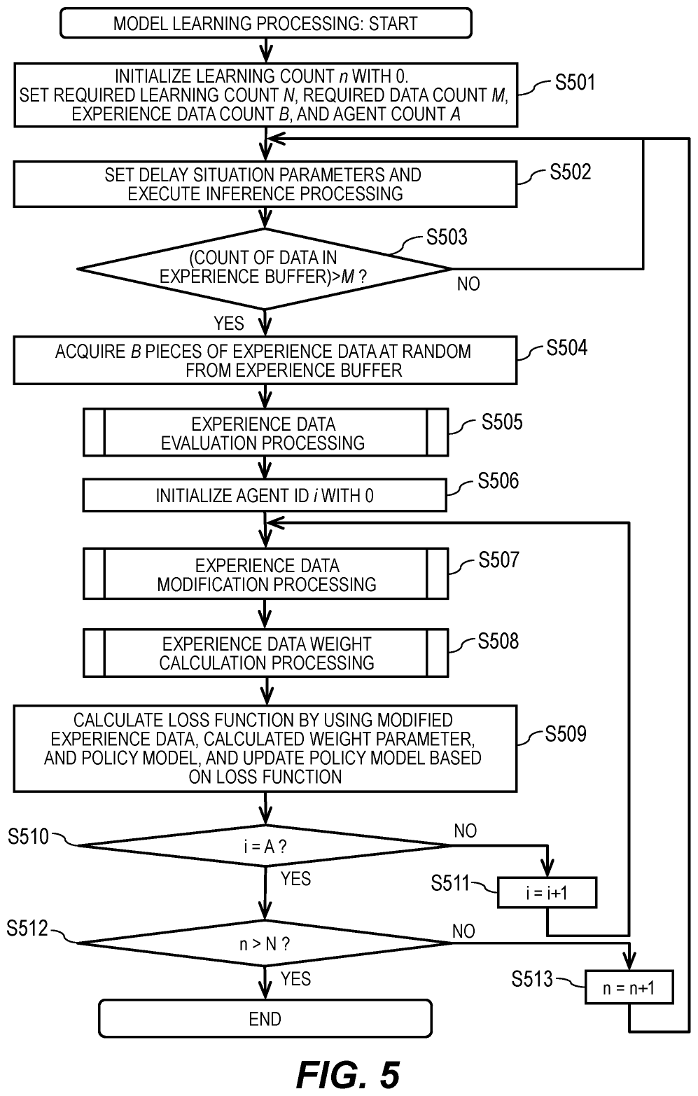

The reinforcement learning program 140 is a program that causes the processor 104 to execute update of the at least one policy parameter of the policy model 115, and causes the processor 104 to function as a reinforcement learning module. The reinforcement learning program 140 includes an experience data evaluation program 141, an experience data modification program 142, an experience data weight calculation program 143, and a model updating program 144. A specific example of processing of the reinforcement learning program 140 is described later with reference to FIG. 5.

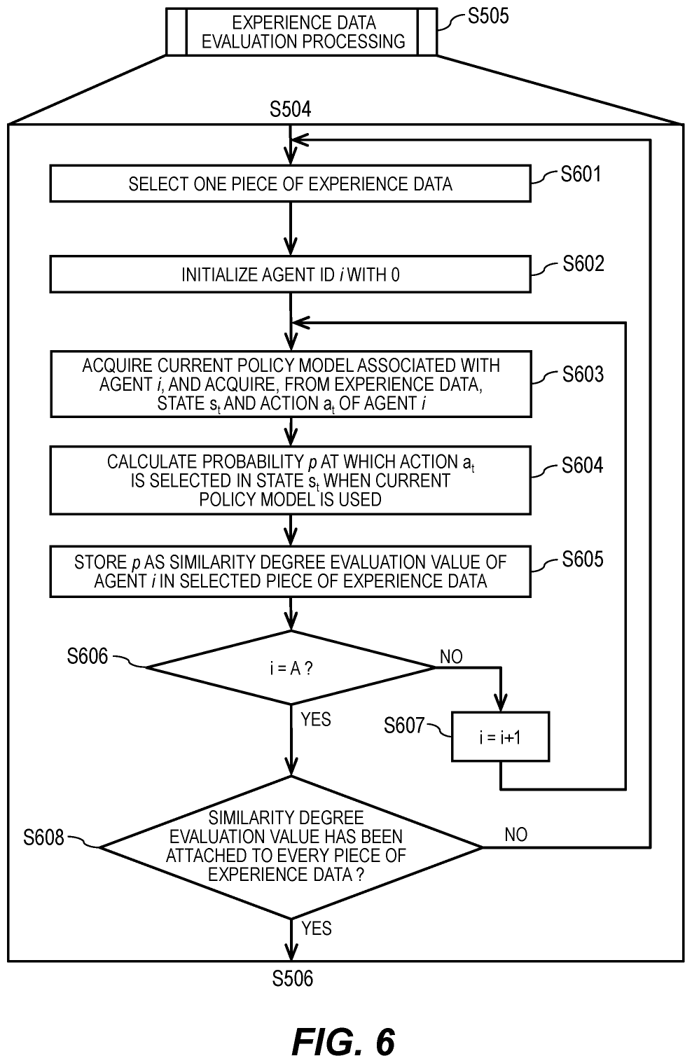

The experience data evaluation program 141 is a program that causes the processor 104 to execute processing of evaluating the degree of similarity of a policy in the experience data to the policy model 115 with use of the experience data in the experience buffer 116 and the policy model 115, and storing the evaluation in association with the experience data, and causes the processor 104 to function as an evaluation module. A value of this evaluation is hereinafter referred to as “similarity degree evaluation value.” One operation arrangement plan 114 and another operation arrangement plan 114 resemble each other more when the similarity degree evaluation value is larger, and are less similar to each other when the similarity degree evaluation value is smaller. A specific processing example of the experience data evaluation program 141 is described later with reference to FIG. 6.

The experience data modification program 142 is a program that causes the processor 104 to execute processing of updating some or all of a plurality of pieces of experience data selected from the experience buffer 116, and causes the processor 104 to function as a modification module. The experience data modification program 142 changes at least one numerical value in the experience data when the similarity degree evaluation value associated with the experience data satisfies a predetermined condition.

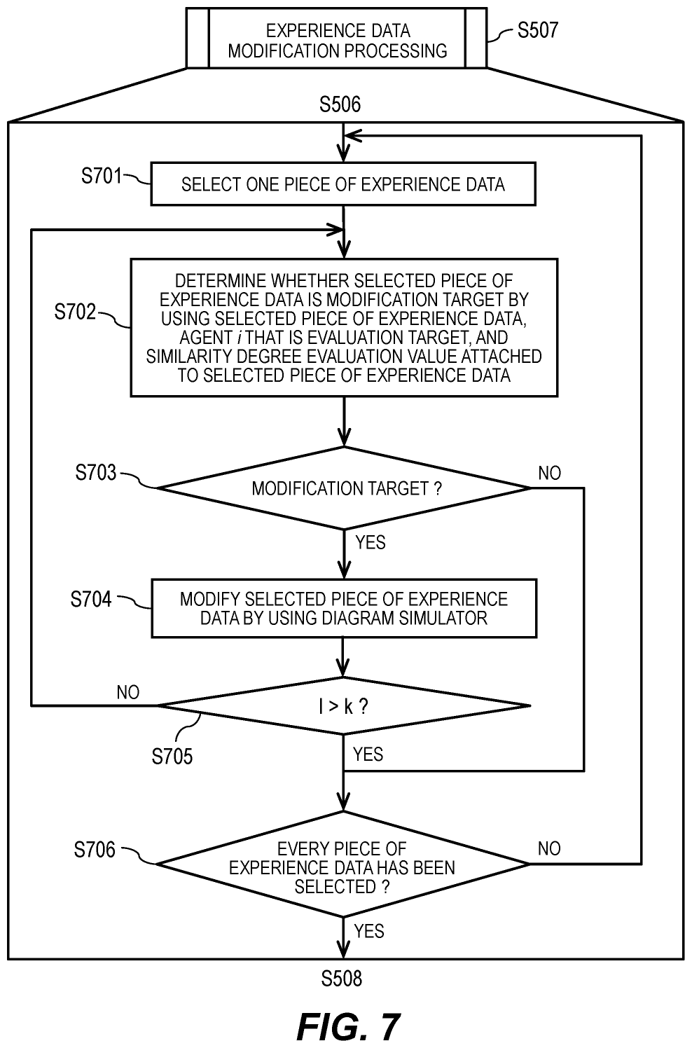

For example, when the similarity degree evaluation value is smaller (the degree of similarity is lower) than a threshold value defined in advance, the experience data modification program 142 uses the current policy model 115 and the diagram simulator 120 to cause the multi-agent inference program 130 to re-execute inference processing, and acquires a new operation arrangement plan that is a result of the re-execution. The experience data modification program 142 then stores the similarity degree evaluation value of the new operation arrangement plan in the experience buffer 116 and thus updates the experience data. A specific processing example of the experience data modification program 142 is described later with reference to FIG. 7.

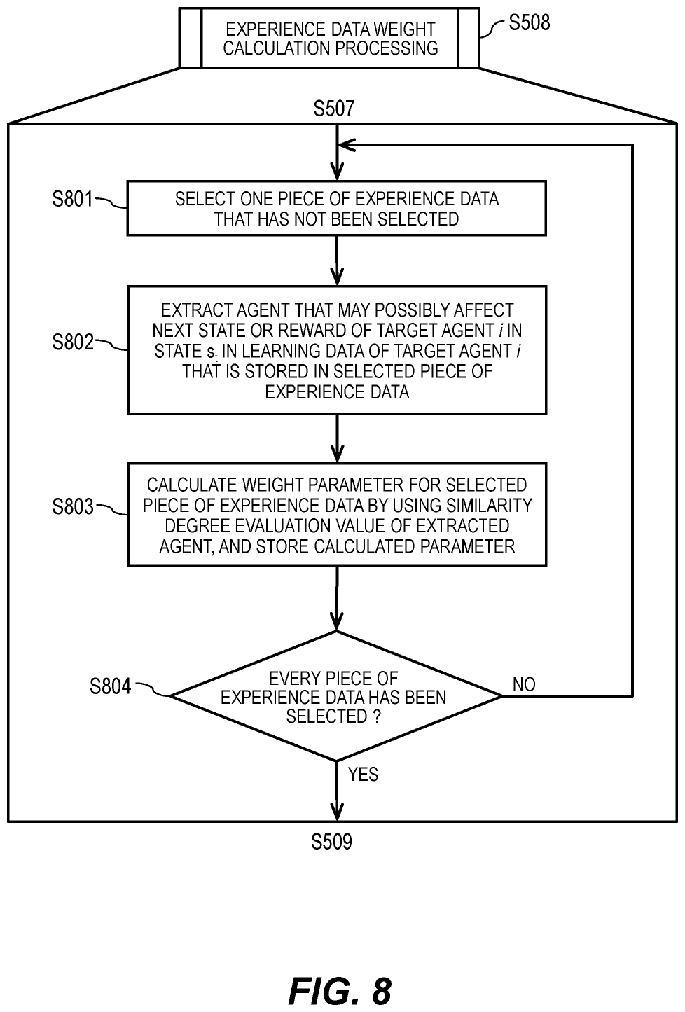

The experience data weight calculation program 143 is a program that causes the processor 104 to execute processing of calculating a learning weight parameter with respect to a plurality of pieces of experience data selected from the experience buffer 116, or the experience data modified by the experience data modification program 142, by using a similarity degree evaluation value that is associated with the selected pieces of experience data or the modified experience data, and causes the processor 104 to function as a calculation module. The learning weight parameter is a parameter indicating how much importance is to be placed on the experience data that is a target when the policy model 115 is updated through processing of the model updating program 144 described later. A specific processing example of the experience data weight calculation program 143 is described later with reference to FIG. 8.

The model updating program 144 is a program that causes the processor 104 to execute processing of updating the at least one policy parameter of the policy model 115 based on at least one piece of experience data or modified experience data, and on the learning weight parameter of the at least one piece of experience data or the modified experience data, and causes the processor 104 to function as an updating module. For example, the model updating program 144 calculates, based on the experience data weighted in a manner depending on the learning weight parameter and the policy model 115, a loss function to be minimized, and updates the at least one policy parameter of the policy model 115 so that the value of the loss function becomes small.

<Diagram Information>

FIG. 2 is an explanatory diagram for showing an example of the diagram information. In FIG. 2, diagram information 200 is shown as data having a table format as an example. The diagram information 200 includes, as fields, a train ID 211, a station ID 212, an arrival time 213, a departure time 214, and a track number 215. A combination of values of the fields in the same row is an entry indicating an operation schedule of a train at a station.

The train ID 211 is identification information for uniquely identifying a train. A train having “#” (#represents a numeral) as the train ID 211 is noted as “train #.” The station ID 212 is identification information for uniquely identifying a station. A station having “X” (X represents an upper-case alphabet letter) as the station ID 212 is noted as “X station.” The arrival time 213 is a time at which the train identified by the train ID 211 arrives at the station identified by the station ID 212. The departure time 214 is a time at which the train identified by the train ID 211 leaves the station identified by the station ID 212. The track number 215 is identification information for uniquely identifying a track or a platform at which the train identified by the train ID 211 arrives or from which the identified train leaves in the station identified by the station ID 212.

The diagram information 200 shown in FIG. 2 has, as an example, the arrival time 213, the departure time 214, and the track number 215 at each of seven stations expressed as A station to G station for each of a train 1 to a train 4. The diagram information 200 is not limited to information shown in FIG. 2, and may additionally include, for example, information about connections between trains, information about crew members, and information about way stations.

FIG. 3 is an explanatory diagram for illustrating a structure example of the experience data stored in the experience buffer 116. The experience buffer 116 holds at least one piece of experience data 300. The experience data 300 is history information of inference executed in the past. Specifically, the experience data 300 includes, for example, learning data 301-1 to 301-k (k is an integer equal to or more than 1) related to all agents 1 to k in inference processing executed in the past, and event data 302 about the whole inference processing. The learning data 301-1 to 301-k related to the agents 1 to k are simply noted as “learning data 301 related to agents” when not being discriminated from one another.

Each piece of the learning data 301 related to agents includes, at least, an environment state 311 observed by an agent that is a target, an action 312 selected in that state, a reward 313 earned as a result of selecting the action 312, a next state 314 that is a state of the environment observed as a result of the action 312, and a policy 315. The policy 315 is replicated data of the policy 115 at a time when the action 312 is selected and the experience data 300 is recorded.

The event data 302 is data other than information related to a specific agent out of data required to replicate the inference processing, and is data including, for example, initial delay data 321, operation arrangement history information 322 of operation arrangements up to a point immediately before the action 312 is taken, or constraint violation information 323 about constraint violation committed due to the action 312.

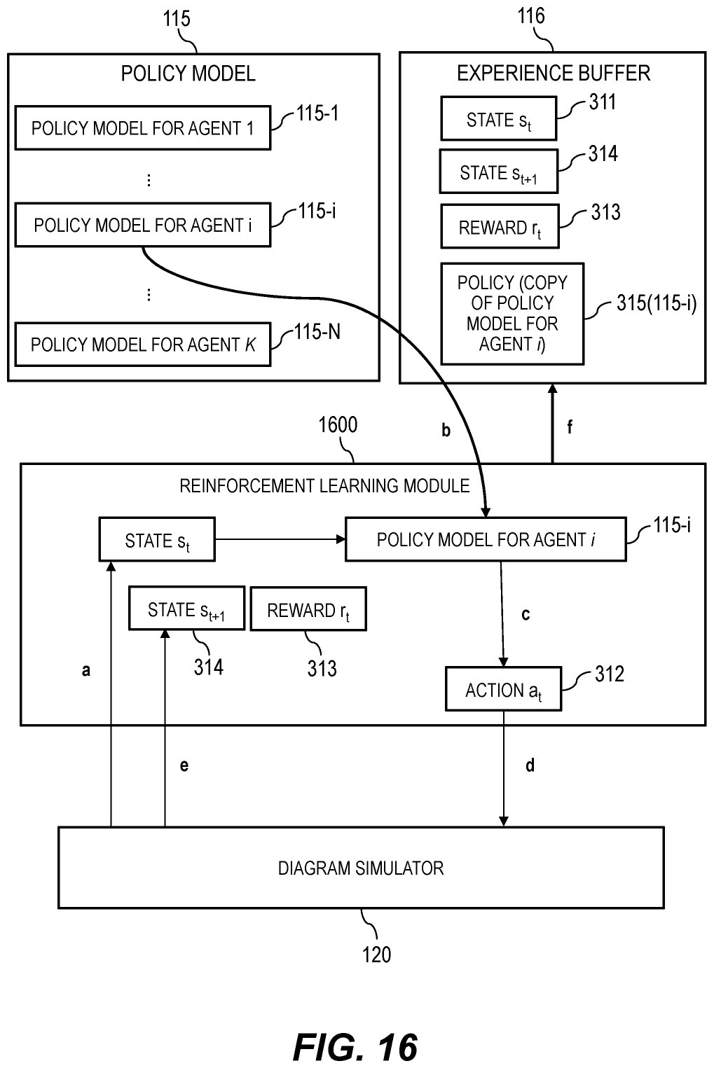

FIG. 16 is an explanatory diagram for illustrating an example of reinforcement learning by the inference apparatus 100. A reinforcement learning module 1600 is a function module implemented by executing the reinforcement learning program 140 with the processor 104. The reinforcement learning module 1600 executes the following “a” to “g.”
“a”: The reinforcement learning module 1600 acquires a state sₜ at a time step t from the diagram simulator 120.
“b”: The reinforcement learning module 1600 acquires a policy model 115-i of an agent i (i is an integer from 1 to k) from the policy model 115.
   “c”: The reinforcement learning module 1600 uses the policy model 115-i acquired in “b” to calculate an action aₜ.
“d”: The reinforcement learning module 1600 gives the action aₜ calculated in “c” to the diagram simulator 120.
“e”: The diagram simulator 120 uses the action aₜ given in “d” to generate a reward rₜ and a state sₜ₊₁ of a next time step t+1, and gives the generated reward and state to the reinforcement learning module 1600.
“f”: The reinforcement learning module 1600 stores the state sₜ, the policy model 115-i, the action aₜ, the reward rₜ, and the state sₜ₊₁ acquired in “a” to “e” in the experience buffer 116.

After repeating “a” to “f” described above a predetermined number of times, the reinforcement learning module 1600 updates a copy of the policy model 115-i, and a final result of the update is a policy model 315.

<Multi-Agent Inference Processing>

FIG. 4 is a flow chart for illustrating an example of multi-agent inference processing steps executed by the multi-agent inference program 130. The multi-agent inference processing is processing of outputting the operation arrangement plan 114 based on data stored in the storage device 101.

The multi-agent inference program 130 first acquires the delay situation parameters 110. The multi-agent inference program 130 next uses the diagram simulator 120, the planned diagram 111, and the delay situation parameters 110 to generate the modified diagram 113, and stores the modified diagram 113 in the storage device 101 (Step S401).

The multi-agent inference program 130 subsequently initializes the modified diagram 113 with the post-delay diagram 112 (Step S402). The multi-agent inference program 130 next uses the planned diagram 111 and the post-delay diagram 112 to set a plurality of agents to which the policy model 115 is applied (Step S403).

One agent corresponds to one train. “Setting an agent” means to store information required to calculate an input variable of the policy model 115 based on the diagram information 200, and the policy model 115 in association with each other. For example, in order to set an agent that determines whether to pass a delayed train to every station at which passing of the delayed train is executable, the multi-agent inference program 130 stores the train ID 211 for identifying the delayed train, the station ID 212 for identifying a station at which the passing is executable, and the policy model 115 for outputting whether to execute the passing as agent setting information in the storage device 101.

The multi-agent inference program 130 next uses the stored agent setting information and the diagram information 200 to calculate the state 311 of each agent which is an input variable of the policy model 115 (Step S404). The state 311 is information required to determine whether to pass with the use of the policy model 115, out of the diagram information 200, and includes, for example, planned departure times and post-delay departure times of trains that precede and follow the agent's train (a train for which whether to pass the delayed train is determined).

The multi-agent inference program 130 subsequently applies, for each agent, the policy model 115 associated with the agent to the state 311 calculated for the agent, to thereby acquire the action 312 which is an output result, adds the action 312 to the operation arrangement plan, and stores the operation arrangement plan in the storage device 101 (Step S405). The action 312 is one variable or a plurality of variables by which, when combined with the agent setting information, an operation arrangement is identifiable.

For example, the action 312 that is an output result of the policy model 115 for determining whether to pass the delayed train takes a value of “0” or “1.” The value “0” corresponds to execution of no new operation arrangement, and “1” corresponds to execution of an operation arrangement that causes the train (a train for which whether to pass the delayed train is determined) corresponding to an agent of interest to pass the delayed train at a station associated with the agent.

The multi-agent inference program 130 subsequently converts the action 312 of each agent into an operation arrangement, applies the operation arrangement to the diagram simulator 120 to acquire a new modified diagram 113, and stores the new modified diagram 113 in the storage device 101 (Step S406).

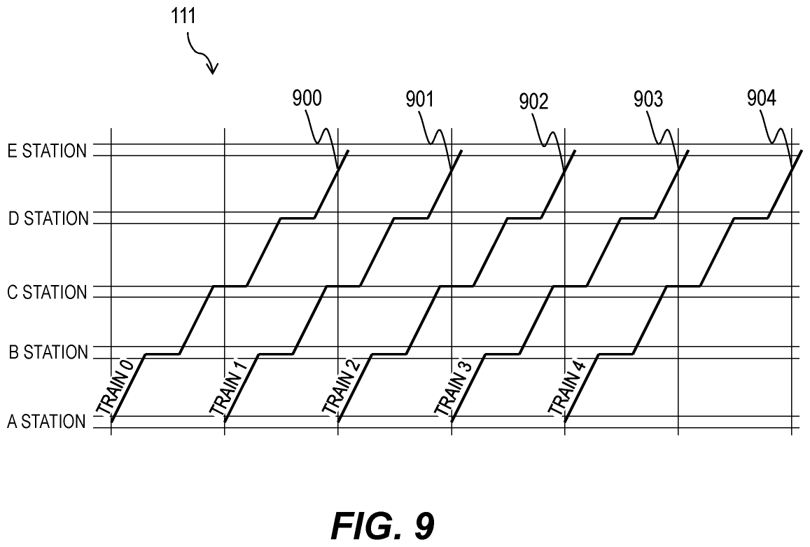

The multi-agent inference program 130 next calculates, for each agent, from the planned diagram 111, the post-delay diagram 112, and the modified diagram 113, the reward 313 to be given to the agent, and sets a completion flag indicating whether the operation arrangement is complete (Step S407). A calculation example of the reward 313 is described later with reference to FIG. 9 to FIG. 14. The completion flag is a positive value or a negative value. The completion flag having a positive value indicates completion of the multi-agent inference processing, and the completion flag having a negative value indicates that the multi-agent inference processing is to be re-executed.

A condition for rendering further re-execution of the multi-agent inference processing unrequired is set as the value of the completion flag. For example, the completion flag may be set so as to take a positive value in a case in which every agent has executed the determination twice, or in a case in which the action associated with “0” has been taken a plurality of times in succession.

Next, the multi-agent inference program 130 stores the data used in the inference in the experience buffer 116 as the experience data 300 (Step S408).

The multi-agent inference program 130 next determines whether the completion flag is positive or negative (Step S409). When the completion flag is negative (Step S409: No), the multi-agent inference processing returns to Step S404 to continue. When the completion flag is positive (Step S409: Yes), on the other hand, the multi-agent inference program 130 ends the multi-agent inference processing.

<Model Learning Processing>

FIG. 5 is a flow chart for illustrating an example of model learning processing steps executed by the reinforcement learning program 140. The reinforcement learning program 140 first initializes a learning count n (n is an integer equal to or more than 0) with 0, and sets a required learning count N, a required data count M, an experience data count B, and an agent count A (Step S501). Those constants N, M, B, and A are each an integer equal to or more than 1, and may be, for example, data set in advance, or data input from the input device 102.

The reinforcement learning program 140 next updates the delay situation parameters 110, uses the multi-agent inference program 130 to execute the multi-agent inference processing illustrated in FIG. 4, and accumulates the experience data 300 in the experience buffer 116 (Step S502). The delay situation parameters 110 may be data determined based on a rule laid out in advance, or may be data selected at random from a certain range.

The reinforcement learning program 140 next determines whether the number of pieces of data stored in the experience buffer 116 is greater than the required data count M set in Step S501 (Step S503). When the number of pieces of stored data is not greater than the required data count M (Step S503: No), the process returns to Step S502 in which the reinforcement learning program 140 newly executes the inference processing to accumulate the experience data 300 in the experience buffer 116.

When the number of pieces of stored data is greater than the required data count M (Step S503: Yes), the reinforcement learning program 140 acquires B pieces of experience data 300 from the experience buffer 116 (Step S504).

The reinforcement learning program 140 next executes experience data evaluation processing for the B pieces of experience data 300 acquired in Step S504 (Step S505). The experience data evaluation processing (Step S505) is processing of evaluating, for each agent, whether an action of the agent in the experience data 300 of a past is similar to a corresponding action of the agent of the present, and storing a similarity degree evaluation value thereof. A specific processing example of the experience data evaluation processing (Step S505) is described later with reference to FIG. 6.

The reinforcement learning program 140 next initializes an index i of an agent ID for identifying an agent with 0 in order to execute processing for each agent (Step S506). An agent having the index i is notated as “agent i.” The reinforcement learning program 140 applies a series of processing steps of from Step S507 to Step S509 to every agent i one agent at a time.

The reinforcement learning program 140 executes experience data modification processing (Step S507). The experience data modification processing (Step S507) is processing of changing the value of a specific piece of experience data 300 that satisfies a condition, out of the B pieces of experience data 300 selected from the experience buffer 116. This condition is, for example, the similarity degree evaluation value in that piece of experience data 300 being smaller than a threshold value determined in advance. A specific processing example of the experience data modification processing (Step S507) is described later with reference to FIG. 7.

The reinforcement learning program 140 next executes experience data weight calculation processing (Step S508). The experience data weight calculation processing (Step S508) is processing of attaching, to a specific piece of experience data 300, a weight parameter indicating how much consideration is to be given in learning. A specific processing example of the experience data weight calculation processing (Step S508) is described later with reference to FIG. 8.

The reinforcement learning program 140 next uses the experience data modified in the experience data modification processing (Step S507) and the weight parameter attached in the experience data weight calculation processing (Step S508) to calculate a loss function, and updates, based on the loss function, the policy model 115 associated with the agent i (Step S509). The reinforcement learning program 140 determines whether the index i matches the agent count A (Step S510).

When the index i is not A (Step S510: No), the reinforcement learning program 140 increments the index i (Step S511), and the process returns to the experience data modification processing (Step S507). When the index i matches the agent count A (Step S510: Yes), on the other hand, the reinforcement learning program 140 determines whether the learning count n is higher than the required learning count N (Step S512).

When the learning count n is not higher than the required learning count N (Step S512: No), the reinforcement learning program 140 increments the learning count n (Step S513), and the process returns to Step S502. When the learning count n is higher than the required learning count N (Step S512: Yes), on the other hand., the reinforcement learning program 140 ends the learning processing.

<Experience Data Evaluation Processing (Step S505)>

FIG. 6 is a flow chart for illustrating an example of detailed processing steps of the experience data evaluation processing (Step S505) executed by the experience data evaluation program 141. The experience data evaluation program 141 first selects one piece of experience data 300 that has not been selected from the B pieces of experience data 300, and stores the selected piece of experience data 300 in the memory 105 (Step S601).

The experience data evaluation program 141 next initializes the index i of the agent ID with 0 (Step S602). The experience data evaluation program 141 next acquires the policy model 115-i for the agent i, the state sₜ and the action aₜ of the agent i in the selected piece of experience data 300, and stores the acquired policy model, state, and action in the memory 105 (Step S603).

The experience data evaluation program 141 subsequently calculates a probability “p” at which the action aₜ is selected under the state sₜ when the current policy model 115-i is used (Step S604). The probability “p” is calculated by Expression (1).

$$p = {π}_{t} ( {a}_{t} \vert {s}_{t} ) = \{ \begin{matrix}1 - ε & {a}_{t} = {arg}_{{{a}_{t}}^{′}} max \{ Q ( {s}_{t} , {{a}_{t}}^{′} ) \} \\ ε / ( N ( A ) - 1 ) & otherwise\end{matrix} \qquad ( 1 )$$

In Expression (1), Q( ) of a right-hand side is an action value function representing the policy model 115, aₜ′ represents the action 312 of the policy 315 at that time, and ε represents a freely set value equal to or more than 0 and less than 1. When ε=1 is true, the action aₜ is selected completely aₜ random, and when ε=0 is true, the action aₜ is selected in accordance with the policy model 115-i alone. “N(A)” represents a total count of possible actions to be taken by the agent.

The experience data evaluation program 141 subsequently stores, as the similarity degree evaluation value of the agent i in the selected piece of experience data 300 of Step S601, the probability “p” calculated in Step S604 in association with the selected piece of experience data 300 (Step S605).

To give a specific example, the experience data evaluation program 141 compares the policy model 115-i and the policy 315 stored in the experience data 300, and determines “1” to be the similarity degree evaluation value when the degree of similarity between the two is equal to or higher than a predetermined threshold value, and determines “0” to be the similarity degree evaluation value when the degree of similarity is lower than the predetermined threshold. In other words, the similarity degree evaluation value is “1” when the action aₜ obtained as output of the policy 315 and the action aₜ obtained as output of the policy model 115-i are found out by direct comparison to be a match, and is “0” when the two do not match. The experience data evaluation program 141 may determine the similarity degree evaluation value by comparing a probability of selecting the action aₜ that is output of the policy 315 and the probability of selecting the action aₜ that is output of the policy model 115-i to each other. Then, the similarity degree evaluation value is “1” when the degree of similarity (a difference between the probabilities in this case) is equal to or higher than a predetermined threshold value, and is “0” when the degree of similarity is lower than the predetermined threshold value.

The experience data evaluation program 141 next determines whether the index i matches the agent count A (Step S606). When the index i is other than A (Step S606: No), the experience data evaluation program 141 increments the index i (Step S607), and the process returns to Step S603. When the index i matches the agent count A (Step S606: Yes), on the other hand, the experience data evaluation program 141 determines whether a similarity degree evaluation value has been attached to every piece of experience data 300 (Step S608).

When it is determined that not every piece of experience data 300 has a similarity degree evaluation value attached thereto (Step S608: No), the process returns to Step S601. When it is determined that a similarity degree evaluation value has been attached to every piece of experience data 300 (Step S608: Yes), on the other hand, the experience data evaluation program 141 ends the processing.

<Experience Data Modification Processing (Step S507)>

FIG. 7 is a flow chart for illustrating an example of detailed processing steps of the experience data modification processing (Step S507) executed by the experience data modification program 142. The experience data modification program 142 first selects a piece of experience data 300 that has not been selected from the B pieces of experience data 300, and stores the selected piece of experience data 300 in the memory 105 (Step S701).

The experience data modification program 142 next uses the selected piece of experience data 300, the evaluation target agent i, and the similarity degree evaluation value attached to the selected piece of experience data 300 to determine whether the selected piece of experience data 300 is a modification target (Step S702). For example, the experience data modification program 142 refers to each similarity degree evaluation value evaluated for the degree of similarity between the stored past policy 315 and the current policy 315 (any similarity degree evaluation value attached to the selected piece of experience data 300 other than the similarity degree evaluation value of the evaluation target agent i), determines the selected piece of experience data 300 to be a modification target when an average value of similarity degree evaluation values of agents other than the evaluation target agent i that are attached to the selected piece of experience data 300 is smaller than a certain value, and ends the processing step of Step S702.

When the experience data modification program 142 determines that the selected piece of experience data 300 is not a modification target (Step S703: No), the process proceeds to Step S706. When the selected piece of experience data 300 is determined to be a modification target (Step S703: Yes), the experience data modification program 142 modifies the selected piece of experience data 300 with the use of the diagram simulator 120 (Step S704).

For example, the experience data modification program 142 inputs the state 311 of each agent i to the current policy 315, to thereby re-acquire the action 312 of each agent i. The experience data modification program 142 replaces the action 312 in the learning data 301-i of every agent i for which the similarity degree evaluation value is determined to be a certain level or lower with the re-acquired action 312, and instructs the multi-agent inference program 130 to re-execute the multi-agent inference processing.

The experience data modification program 142 then re-calculates the state 311 and the reward 313 in the learning data 301-i of the agent i, based on new diagram information obtained by the re-execution of the multi-agent inference processing, and overwrites contents of the selected piece of experience data 300. In this manner, the state 311, the action 312, and the reward 313 in the selected piece of experience data 300 are modified with the re-calculated state 311, the re-acquired action 312, and the re-calculated reward 313.

The experience data modification program 142 next determines whether i>k is true (Step S705). When i>k is not true (Step S705: No), the process returns to Step S702. When i>k is true (Step S705: Yes), on the other hand, the experience data modification program 142 determines whether every piece of experience data 300 has been selected in Step S701 (Step S706). When it is determined that not every piece of experience data 300 has been selected in Step S701 (Step S706: No), the process returns to Step S701. When it is determined that every piece of experience data 300 has been selected in Step S701 (Step S706: Yes), on the other hand, the experience data modification program 142 ends the processing.

<Experience Data Weight Calculation Processing (Step S508)>

FIG. 8 is a flow chart for illustrating an example of detailed processing steps of the experience data weight calculation processing (Step S508) executed by the experience data weight calculation program 143. The experience data weight calculation program 143 first selects one piece of experience data 300 that has not been selected from the B pieces of experience data 300, and stores the selected piece of experience data 300 in the memory 105 (Step S801).

The experience data weight calculation program 143 next extracts another agent j (j≠i) other than the target agent i (Step S802). The another agent j may be, for example, an agent that has a possibility of affecting the next state sₜ₊₁ or the reward rₜ of the agent i under the state sₜ in the learning data 301-i of the target agent i stored in the selected piece of experience data 300. In other words, the another agent j is an agent present within a predetermined influence range from the target agent i. Specifically, the another agent j is, for example, an agent corresponding to a train j within a predetermined length of time from a time of a train i corresponding to the target agent i.

The experience data weight calculation program 143 next uses the similarity degree evaluation value (set in Step S605) of the extracted agent j to calculate a weight parameter for the selected piece of experience data 300, and stores the weight parameter in association with the selected piece of experience data 300 (Step S803). Specifically, the experience data weight calculation program 143 calculates a weight parameter of the target agent i for the selected piece of experience data 300 by, for example, a product of the similarity degree evaluation value of the agent j.

The experience data weight calculation program 143 next determines whether every piece of experience data 300 has been selected in Step S801 (Step S804). When it is determined that not every piece of experience data 300 has been selected in Step S801 (Step S804: No), the process returns to Step S801. When it is determined that every piece of experience data 300 has been selected in Step S801 (Step S804: Yes), on the other hand, the experience data weight calculation program 143 ends the processing.

Description is given below with reference to FIG. 9 to FIG. 14 on a specific example and obtained effects of the experience data evaluation processing (Step S505), the experience data modification processing (Step S507), and the experience data weight calculation processing (Step S508) in the model learning processing illustrated in FIG. 5 which is executed by the reinforcement learning program 140.

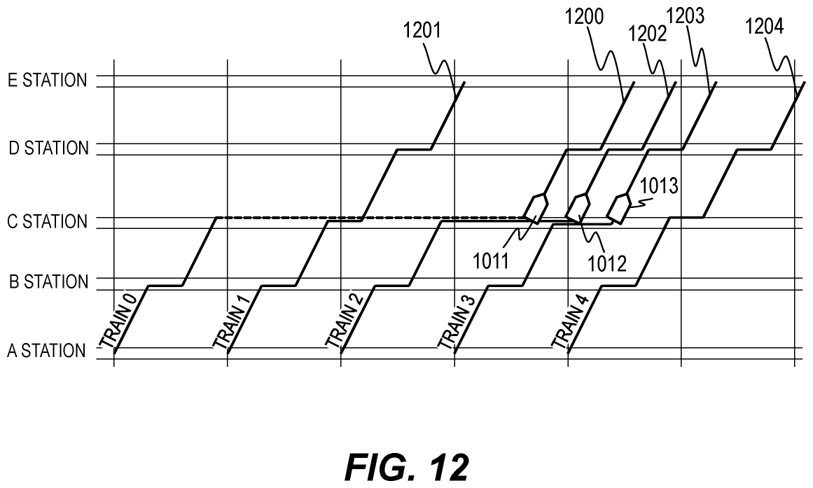

FIG. 9 is a graph for showing the planned diagram 111. In the graph of FIG. 9, an axis of abscissa represents time, an axis of ordinate represents stations, and bold lines indicate positions of trains at respective times. The same applies to FIG. to FIG. 12. The planned diagram 111 shown in FIG. 9 is operation schedules 900 to 904 including the arrival time 213 and the departure time 214 of each of five trains (Train 0 to Train 4) at each of five stations (A station to E station). In the following description, the five trains (Train 0 to Train 4) are referred to as “Train 0 (the operation schedule 900),” “Train 1 (the operation schedule 901),” “Train 2 (the operation schedule 902),” “Train 3 (the operation schedule 903),” and “Train 4 (the operation schedule 904)” in chronological order of departure time at the A station.

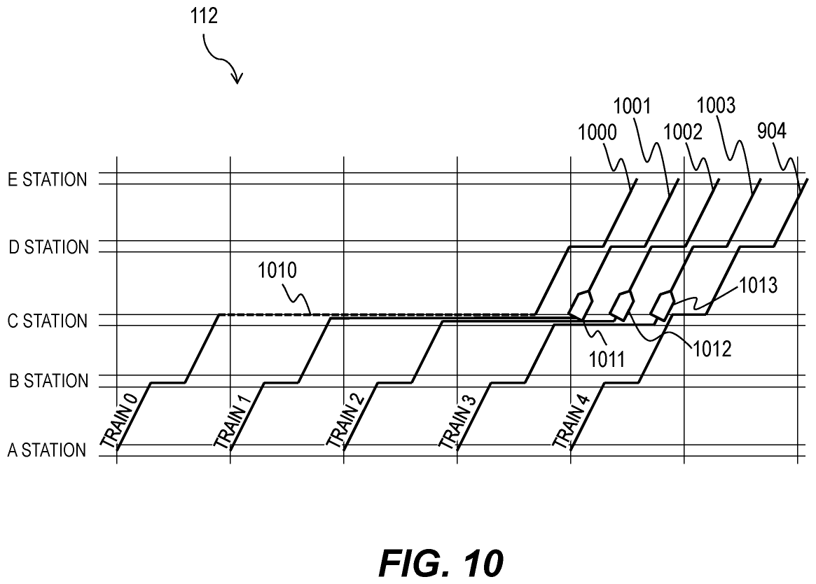

FIG. 10 is a graph for showing the post-delay diagram 112. In the post-delay diagram 112 shown in FIG. 10, a delay of Train 0 at the C station as indicated by a broken line 1010 is causing delays of the subsequent Train 1 to Train 3. Operation schedules 1000 to 1003 are changed operation schedules of Train 0 to Train 3 which are changed from the operation schedules 900 to 903 due to the delay of Train 0. In the post-delay diagram 112, Train 4 is not delayed.

In order to execute operation arrangement for the post-delay diagram 112, the inference apparatus 100 sets multi-agent as follows. First, the inference apparatus 100 define agents as what determine, when there is a delay at a station, whether a train that is not the cause of the delay is to pass a train that is the cause of the delay at the station at which the delay has occurred. In an example of FIG. 10, Train 1 to Train 3 each qualify as “a train that is not the cause of the delay when there is a delay at a station.” The “station at which the delay has occurred” is the C station. The “train that is the cause of the delay” is Train 0.

Agents corresponding to Train 1, Train 2, and Train 3 are hereinafter referred to as “Agent 1,” “Agent 2,” and “Agent 3,” respectively. In FIG. 10, pentagons 1011, 1012, and 1013 are displayed to indicate points that are starting points for determination by Agents 1 to 3. Definitions of states that serve as input variables when Agents 1 to 3 apply policies are created from the diagram information.

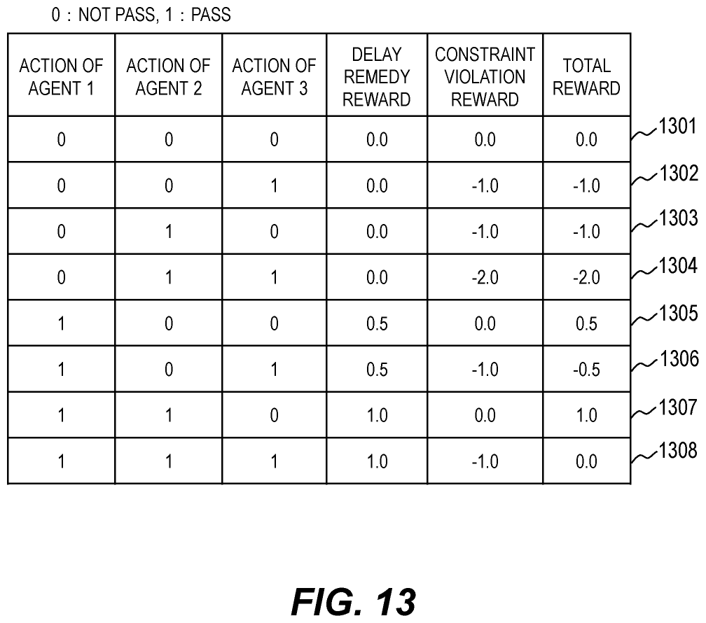

Specific definitions of the states are not important in the example illustrated in FIG. 9 to FIG. 13. The reward 313 earned by the action 312 of each of Agents 1 to 3 is determined by a sum of a delay remedy reward, which takes a greater value when a delay is remedied more, and a constraint violation reward, which is a negative reward given when constraint violation is committed, and this applies in common to all of Agents 1 to 3. A specific example of the reward 313 that can be earned is described later with reference to FIG. 13.

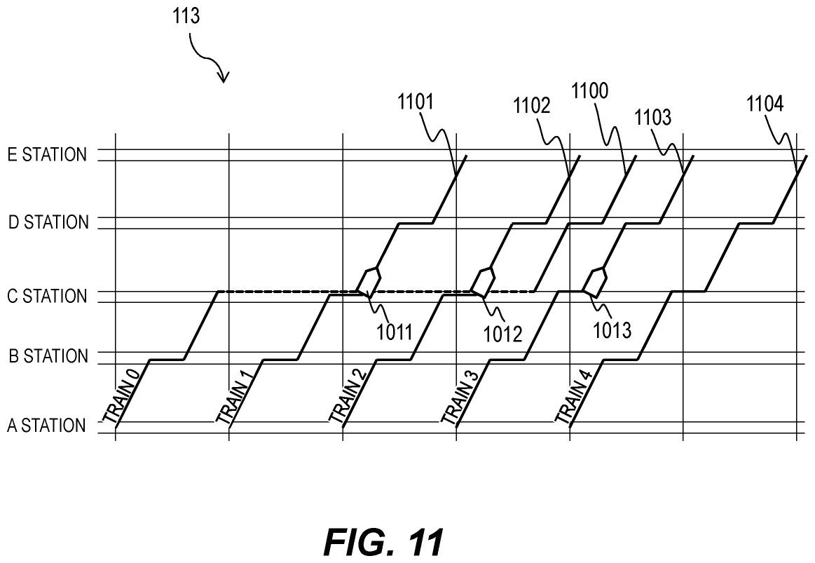

FIG. 11 is a graph for showing an example of the modified diagram 113. The modified diagram 113 shown in FIG. 11 is diagram information obtained when Agent 1 and Agent 2 take an action of executing an operation arrangement for passing Train 0 for the post-delay diagram 112. Delays of Train 1 and Train 2 are solved by passing Train 0, and, with the departure time 214 at which Train 1 leaves the C station and the departure time 214 at which Train 2 leaves the C station advanced, a delay of Train 3 is solved as well.

FIG. 12 is a graph for showing another example of the modified diagram 113. The modified diagram 113 shown in FIG. 12 is obtained when Agent 1 alone takes an action of executing an operation arrangement for passing Train 0 for the post-delay diagram of FIG. 10. The delay of Train 1 is solved by passing Train 0, but the delays of Train 2 and Train 3 are, although smaller than in the post-delay diagram 112, not completely solved.

FIG. 13 is an explanatory diagram for showing an example of a reward table. A reward table 1300 is a table defining rewards that are earned as a result of actions taken by Train 1, Train 2, and Train 3 for the post-delay diagram 112 shown in FIG. 10. The reward table 1300 is stored in the storage device 101.

In columns for actions of Agent 1 to Agent 3, a value “0” indicates that the train corresponding to that agent chooses not to pass the delayed train, and a value “1” indicates that the train chooses to pass the delayed train. In a case in which Train 1 corresponding to Agent 1 does not pass the delayed Train 0, the action of Agent 1 is “0” and is classified into patterns 1301 to 1304. The delay remedy reward for this action is “0.0.” This is because, when Train 1 corresponding to Agent 1 does not pass the delayed Train 0 as in the patterns 1301 to 1304, Train 2 and Train 3 cannot pass the delayed Train 0 as well, with the result that the delays are not remedied.

In a case in which only Train 1 corresponding to Agent 1 passes the delayed train, the action of Agent 1 is “1” (classified into patterns 1305 and 1306), and the delay remedy reward for this action is “0.5.” This corresponds to a state shown in FIG. 12 in which the delays are partially remedied but are not completely solved.

In a case in which Train 1 and Train 2 pass the delayed train, actions of Agent 1 and Agent 2 are both “1” (classified into patterns 1307 and 1308), and the delay remedy reward for the action is “1.0.” This corresponds to a state shown in FIG. 12 in which the delays of all trains except Train 0 as the cause of the delays are remedied, and a great reward is accordingly given.

Train 3 cannot pass Train 0 because a planned departure time at which Train 3 is scheduled to leave the C station is later than a post-delay departure time of Train 0. Train 3 accordingly does not affect the delay remedy reward.

The constraint violation reward is described next. The constraint violation reward is a negative reward given when an action that does not satisfy a constraint condition is taken. In this example, when an operation arrangement for passing the delayed train is given under a state in which the passing is inexecutable, this operation arrangement is not executed and a negative reward of “−1.0” is given.

For example, in a case in which Train 2 takes an action of passing the delayed train when Train 1 chooses not to pass the delayed train, the action of Agent 1 is “0” and the action of Agent 2 is “1” (classified into the patterns 1303 and 1304). The action of Agent 2 is invalid and a negative reward of −1.0 is given.

Train 3 cannot pass the delayed train in all cases, and when Agent 3 takes an action of passing the delayed train, this action of Agent 3 is “1” (classified into the patterns 1302, 1304, 1306, and 1308) and a negative reward of −1.0 is always given.

Learning processing in problem settings shown in FIG. 9 to FIG. 13 is described below. The policy model 115 associated with each of Agent 1, Agent 2, and Agent 3 selects an action at random in the beginning of learning, and, as the learning progresses, comes to select, at a higher probability, an action that earns a great reward.

First, a probability at which Agents 1 to 3 take the action “0” and a probability at which Agents 1 to 3 take the action “1” are equally 0.5 in the beginning of the learning, and the eight patterns of operation arrangement shown in FIG. 13 are accordingly applied at the same probability and stored in the experience buffer 116.

An example is discussed for a case of evaluating the experience data 300 in the experience buffer 116 with the use of the experience data evaluation program 141 in an environment in which Agent 1 to Agent 3 all select the action “0” or the action “1” at an equal probability.

With respect to any piece of experience data 300, a probability at which Agent 1, Agent 2, and Agent 3 take actions stored in the piece of experience data 300 when the current policy is used is 0.5. Accordingly, with respect to every piece of experience data 300, 0.5 is given as the similarity degree evaluation value of Agent 1, 0.5 is given as the similarity degree evaluation value of Agent 2, and 0.5 is given as the similarity degree evaluation value of Agent 3. When such similarity degree evaluation values are given, the similarity degree evaluation values are hereinafter written in a format of [0.5. 0.5. 0.5].

In an environment in which Agents 1 to 3 all select the action 312 at an equal probability, Agent 1 takes the action “0” in four patterns, which are the patterns 1301 to 1304, and a total of sum rewards earned in the patterns 1301 to 1304 is −0.4. An expected value of rewards earned when Agent 1 takes the action “0” is accordingly −0.1 (=−0.4/4). Similarly, an expected value of rewards earned when Agent 1 takes the action “1” is 0.25.

Agent 1 accordingly learns to take the action “1” often. Similarly, Agent 2 has −0.25 as an expected value of rewards for the action “0” and −0.5 as an expected value of rewards for the action “1,” and accordingly learns to take the action “0” often. Agent 3 having 0.125 and −0.875 as expected reward values for the actions “0” and “1,” respectively, similarly learns to take the action “0” often.

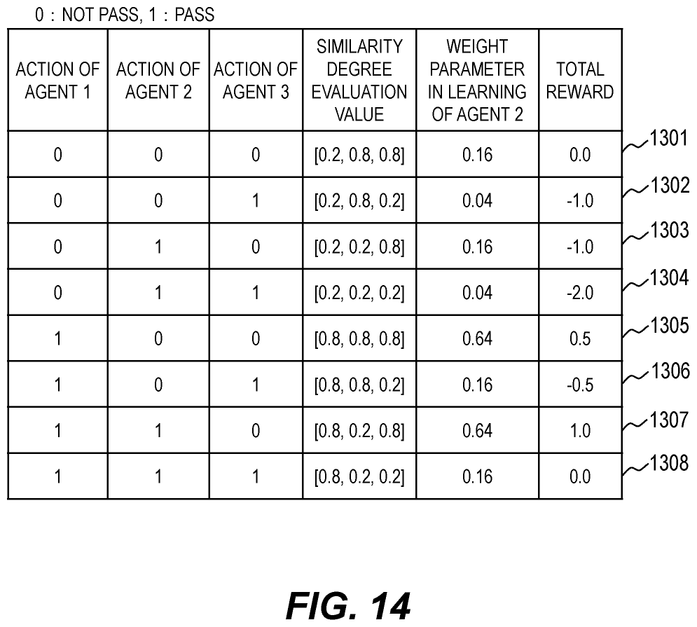

FIG. 14 is a table for showing a relationship between a similarity degree evaluation value with respect to the experience data 300 and a weight parameter. It is assumed that, as a result of learning of the first time, probabilities at which Agent 1, Agent 2, and Agent 3 each take the action “0” have become 0.2, 0.8, and 0.8, respectively (the pattern 1301), and that the probabilities at which Agent 1, Agent 2, and Agent 3 take the action “1” have become 0.8, 0.2, and 0.2, respectively. The table of FIG. 14 organizes evaluation values for eight patterns (the patterns 1301 to 1308) of experience data 300 in the experience buffer 116 and weight parameters to be used in updating the policy of Agent 2 in this environment.

In FIG. 14, when the policy of Agent 2 is updated, a weight parameter is determined by actions of agents that may possibly affect the state and the reward of Agent 2, that is, a product of evaluation values of Agent 1 and Agent 3. When the policy of Agent 2 is updated with use of this weight, a weighted expected value of a reward for the action “0” taken by Agent 2 is 0.2 (a weighted average of the patterns 1301, 1302, 1305, and 1306), and a weighted expected value of a reward for the action “1” is 0.4 (a weighted average of the patterns 1303, 1304, 1307, and 1308). Consequently, the learning of Agent 2 is modified so that the action “1” is taken.

A specific example of learning modification processing in a case in which, as a result of the learning of the first time, evaluation values evaluated with respect to pieces of experience data 300 for when Agent 2 is learned have become as shown in FIG. 13 is described next. A case in which one piece of experience data 300 is selected at random from the pieces of experience data 300 accumulated in the experience buffer 116, and the experience data modification processing (Step S507) described with reference to FIG. 7 is executed is considered.

In the processing step of Step S703 in which whether the selected piece of experience data 300 is a modification target is determined, when a rule is laid down so that modification processing is executed for the experience data 300 that has an evaluation value of 0.5 or less, the experience data modification processing (Step S507) is executed when the patterns of FIG. 14 excluding the patterns 1305 and 1307, which are the patterns 1301 to 1304, 1306, and 1308, are selected as the experience data 300.

In the experience data modification processing (Step S507), the experience data modification program 142 uses, as it is, the action 312 stored in the learning data 301-1 of Agent 2 to be learned, selects actions of other agents (Agent 1 and Agent 3) based on the current policy, creates new learning data 301-2 of Agent 2 with the use of the diagram simulator 120, and uses the new learning data 301-2 in the learning.

For example, when the experience data modification processing (Step S507) is to be executed for a piece of experience data 300 corresponding to the pattern 1301 of FIG. 14, an evaluation value for this piece of experience data 300 is 0.16, and this piece of experience data 300 is accordingly a target of the experience data modification processing (Step S507).

When the experience data 300 is modified, the action of Agent 1 is determined based on the current policy of the agent, and the same action “0” as in the original experience data 300 is accordingly selected at a probability of 0.2, but is corrected to the action “1” at a probability of 0.8. The action 312 of Agent 3 is similar, and the action “0” and the action “1” are selected at a probability of 0.2 and a probability of 0.8, respectively.

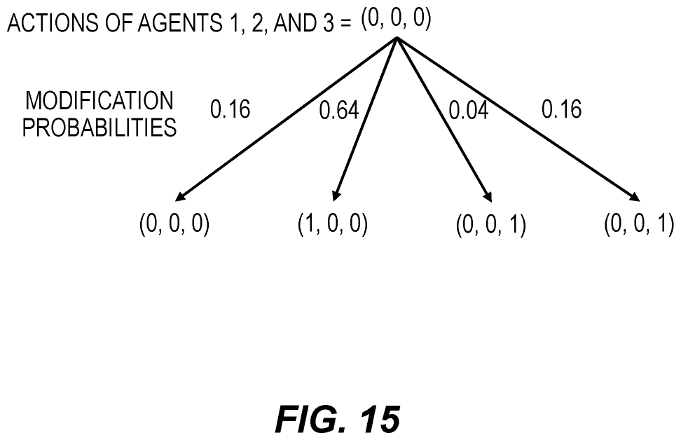

FIG. 15 is an explanatory diagram for illustrating at what probability each piece of original experience data 300 is modified by the experience data modification processing (Step S507). As illustrated in FIG. 15, the experience data 300 is corrected to the experience data 300 corresponding to the pattern 1305 at the highest probability. The same is true for the pattern 1302 and the pattern 1306 in which the action of Agent 2 is “0,” and the pattern 1302 and the pattern 1306 are corrected to the pattern 1305 at the highest probability.

Similarly, the patterns 1303, 1304, and 1308 in which the action of Agent 2 is “1” are corrected to the pattern 1307 at the highest probability. As a result, many pieces of experience data 300 are corrected to the pattern 1305 and the pattern 1307. In this case, a reward of the pattern 1305 when Agent 2 takes the action “0” is 0.5, and a reward of the pattern 1307 when Agent 2 takes the action “1” is 1.0. The reward of the latter is greater and, accordingly, increasing the probability at which the action “1” is taken is learned. Through the experience data modification processing described above (Step S507), the policy 315 of the learning data 301-2 of Agent 2 can be learned so that an optimum action 312 is taken, without newly acquiring the experience data 300.

In this manner, according to the at least one embodiment, with respect to the experience data 300 stored in the experience buffer 116, the inference apparatus 100 compares the policy 315 of the agent i used at the time the stored experience data 300 is collected and the policy 315 used in learning of the agent i, to thereby identify the action 312 of the agent that causes non-stationarity of the environment, and modifies the experience data 300 for which it is determined that the environment differs significantly. The inference apparatus 100 also determines how much the environment is to differ for the experience data 300 to require modification, by utilizing domain knowledge of railroads. Specifically, an action that causes constraint violation greatly changes the reward in reinforcement learning and thus significantly affects non-stationarity of the environment. The inference apparatus 100 actively modifies such data.

This enables taking into consideration of the degree of similarity between the policy 315 of another agent in the experience data 300 and the current policy 315, in order to deal with non-stationarity of an environment in multi-agent learning. Non-stationarity of past data used in multi-agent inference can thus be reduced.

Although the present disclosure has been described with reference to example embodiments, those skilled in the art will recognize that various changes and modifications may be made in form and detail without departing from the spirit and scope of the claimed subject matter. For example, the above-mentioned embodiments are described in detail for a better understanding of this disclosure, and this disclosure is not necessarily limited to what includes all the configurations that have been described. Further, a part of the configurations according to a given embodiment may be replaced by the configurations according to another embodiment. Further, the configurations according to another embodiment may be added to the configurations according to a given embodiment. Further, a part of the configurations according to each embodiment may be added to, deleted from, or replaced by another configuration.

Further, a part or entirety of the respective configurations, functions, processing modules, processing means, and the like that have been described may be implemented by hardware, for example, may be designed as an integrated circuit, or may be implemented by software by a processor interpreting and executing programs for implementing the respective functions.

The information on the programs, tables, files, and the like for implementing the respective functions can be stored in a storage device such as a memory, a hard disk drive, or a solid state drive (SSD) or a recording medium such as an IC card, an SD card, or a DVD.

Further, control lines and information lines that are assumed to be necessary for the sake of description are described, but not all the control lines and information lines that are necessary in terms of implementation are described. It may be considered that almost all the components are connected to one another in actuality.

What is claimed is:

1. An inference apparatus, comprising:
an inference module configured to infer a modification plan for modification target data by inputting, for each of a plurality of agents, a state of the each of the plurality of agents to a policy model of the each of the plurality of agents which is related to the modification target data, and by acquiring an action of the each of the plurality of agents, and store, as experience data, the state and the action of each of the plurality of agents as well as a reward earned by taking the action;
an evaluation module configured to calculate an evaluation value for each of the plurality of agents, the evaluation value being a probability at which the action is selected under the state; and
a modification module configured to modify the experience data based on the evaluation value of each of the plurality of agents calculated by the evaluation module.

2. The inference apparatus according to claim 1, wherein the modification module is configured to determine, based on the evaluation value of each of the plurality of agents, whether the experience data is a modification target, and modify the experience data when the experience data is the modification target.

3. The inference apparatus according to claim 1, further comprising:
a calculation module configured to calculate a weight parameter of modified experience data modified by the modification module; and
an update module configured to update, based on the modified experience data and on the weight parameter calculated by the calculation module, a policy parameter of the policy model.

4. The inference apparatus according to claim 1, wherein the calculation module is configured to calculate the weight parameter based on the evaluation value of another agent other than a specific agent out of the plurality of agents, the another agent being within an influence range of the specific agent.

5. An inference method, which is executed by an inference apparatus including a processor configured to execute a program and a storage device configured to store the program, the inference method comprising executing, by the processor:
inference processing of inferring a modification plan for modification target data by inputting, for each of a plurality of agents, a state of the each of the plurality of agents to a policy model of the each of the plurality of agents which is related to the modification target data, and by acquiring an action of the each of the plurality of agents, and storing, as experience data, the state and the action of each of the plurality of agents as well as a reward earned by taking the action;
evaluation processing of calculating an evaluation value for each of the plurality of agents, the evaluation value being a probability at which the action is selected under the state; and
modification processing of modifying the experience data based on the evaluation value of each of the plurality of agents calculated in the evaluation processing.

6. A non-transitory recording medium readable by a processor, for causing the processor to execute:
inference processing of inferring a modification plan for modification target data by inputting, for each of a plurality of agents, a state of the each of the plurality of agents to a policy model of the each of the plurality of agents which is related to the modification target data, and by acquiring an action of the each of the plurality of agents, and storing, as experience data, the state and the action of each of the plurality of agents as well as a reward earned by taking the action;
evaluation processing of calculating an evaluation value for each of the plurality of agents, the evaluation value being a probability at which the action is selected under the state; and
modification processing of modifying the experience data based on the evaluation value of each of the plurality of agents calculated in the evaluation processing.
